(19) United States
(12) Patent Application Publication
(10) Pub. No.: US 2016/0177896 A1
(43) Pub. Date: Jun. 23, 2016

(54) Fuel Admission Point Integrated into Intake Runner/Elbow

(71) Applicant: Caterpillar Inc., Peoria, IL (US)

(72) Inventors: Ryan Snodgrass, Fowler, IN (US); Jeff Howard, West Lafayette, IN (US); Michael Gough, Lafayette, IN (US)

(73) Assignee: Caterpillar Inc., Peoria, IL (US)

(21) Appl. No.: 14/577,434

(22) Filed: Dec. 19, 2014

(51) Int. Cl. F02M 35/10

(52) U.S. Cl. CPC F02M 35/10072; F02M 35/10216; F02M 35/10118; F02M 35/10157

(57) ABSTRACT

The disclosure is directed to an intake system for a machine, the intake system including a connector including an inlet portion, a mixing portion and an outlet portion where the connector is configured to flow air sequentially through the inlet portion, the mixing portion and the outlet portion within the connector, a fuel admission valve input where the fuel admission valve input is connected to an outer surface of the connector and is configured to receive fuel that subsequently enters inside the connector and a fuel admission point placed within the connector. The fuel admission point is configured to receive the fuel from the fuel admission valve input and introduce the fuel inside the connector. The fuel admission point is further configured to introduce the fuel inside the connector at an angle with respect to an airflow through the connector to generate a turbulent flow and cause mixing of air and fuel.

### TECHNICAL FIELD

The disclosure generally relates to an intake system for an internal combustion engine of a machine, and more particularly, to an intake system for an internal combustion engine of a machine that more uniformly mixes fuel and intake air.

### BACKGROUND

A system that provides air and fuel to an internal combustion engine of a machine is generally referred to as an intake system. The intake system in general has an air filter, a fuel source, an intake manifold, and the like. In some intake systems, a turbocharger or supercharger may be utilized to increase air pressure to increase performance or the like.

Air typically enters the engine through the air filter to filter out particles that could damage the engine. Downstream from the air filter, fuel is typically introduced into the air stream. For example, fuel injectors typically include jets configured to inject a specific amount of fuel into the air of the intake system, thus creating a mixture of air and fuel.

Thereafter, the air-fuel mixture in some cases may be input to a supercharger or turbocharger system. The supercharger or turbocharger system typically increases a pressure of the air-fuel mixture and generates greater power output from the engine.

The intake manifold typically provides a passage for the air-fuel mixture to the cylinder. The intake manifold usually includes a plenum and intake runners. The plenum typically distributes the air-fuel mixture to various cylinders. From there, the air-fuel is directed to the cylinders through individual intake runners.

U.S. Pat. No. 8,757,133 B1 ('133 patent hereafter) to Czapka discusses a gaseous fuel mixer for an internal combustion engine that includes a mixer body and a mixer element supported in a mixer passage formed in the mixer body. The gaseous fuel mixer attaches to an intake manifold at a first end and receives intake air at a second end. A distal end of the mixer element accepts gaseous fuel from a manifold passage extending from a port positioned in the intake manifold. The gaseous fuel flows through the mixer element and then through a plurality of openings formed in an exposed proximate end of the mixer element. The gaseous fuel mixes with the intake air, and the mixture of intake air and gaseous fuel flows from the second end of the mixer body to the first end of the mixer body and then to the intake manifold. The gaseous fuel mixer in the '133 patent injects fuel into an air stream where the central direction of the injection is generally parallel to the air stream. Such an arrangement of the mixer provides limited mixing of fuel and air.

As a result, there is a need for an intake system to improve mixing, distribution, and uniformity of the fuel-air mixture to increase engine performance without complicating the intake system to manufacture.

### SUMMARY

In one aspect of the disclosure, an intake system for a machine includes a connector including an inlet portion, a mixing portion, and an outlet portion where the connector is configured to guide air sequentially through the inlet portion, the mixing portion and the outlet portion within the connector; a fuel admission valve input connected to an outer surface of the connector where the fuel admission valve input is configured to receive fuel that subsequently enters the connector; and a fuel admission point placed within the connector, the fuel admission point configured to receive the fuel from the fuel admission valve input and introduce the fuel inside the connector, where the fuel admission point is further configured to introduce the fuel inside the connector at an angle with respect to an airflow through the connector to generate a turbulent flow and cause mixing of air and fuel.

Another aspect of the disclosure is directed to a method for mixing fuel and air in an intake system for a machine. The intake system includes a connector including an inlet portion, a mixing portion and an outlet portion; a fuel admission valve input where the fuel admission valve input is connected to an outer surface of the connector; and a fuel admission point placed within the connector where the fuel admission point is configured to receive the fuel from the fuel admission valve input and introduces the fuel inside the connector. The method includes directing air sequentially through the inlet portion, the mixing portion and the outlet portion within the connector; introducing the fuel from the fuel admission valve input to the fuel admission point; introducing the fuel from the fuel admission point to the air flowing from the inlet portion in the connector at an angle with respect to an airflow through the connector to generate a turbulent flow and cause mixing of air and fuel; and guiding the mixed stream of the air and the fuel to the outlet portion.

Another aspect of the disclosure is directed to an intake system for a machine, the intake system including means for directing air where the means for directing air includes an inlet portion, a mixing portion and an outlet portion where the means for directing air is configured to flow air sequentially through the inlet portion, the mixing portion and the outlet portion within the means for directing air; means for receiving fuel where the means for receiving fuel is connected to an outer surface of the means for directing air where the means for receiving fuel is configured to receive the fuel that subsequently enters inside the means for directing air; and means for introducing fuel placed within the means for flowing fuel where the means for introducing fuel is configured to receive the fuel from the means for receiving fuel and introduces the fuel inside the means for directing air, where the means for introducing fuel is configured to introduce the fuel inside the means for directing air at an angle with respect to an airflow through the means for directing air to generate a turbulent flow and cause mixing of air and fuel.

### BRIEF DESCRIPTION OF THE DRAWINGS

FIG. 1 is an illustration of an exemplary machine according to one aspect of the disclosure.

FIG. 2 is an illustration of an intake system for use with the machine of FIG. 1.

FIG. 3 is an illustration of an intake runner for use with the intake system of FIG. 2.

FIG. 4 is an illustration of a cross-sectional view of the exemplary intake runner in FIG. 3.

FIG. 5 is an illustration of a cross-sectional view of another aspect of an intake runner according to the disclosure.

### DETAILED DESCRIPTION

Reference will now be made in detail to exemplary aspects that are illustrated in the accompanying drawings. Wherever possible, the same reference numbers will be used throughout the drawings to refer to the same or like parts. While specific configurations and arrangements are discussed, it should be understood that this is done for illustrative purposes only.

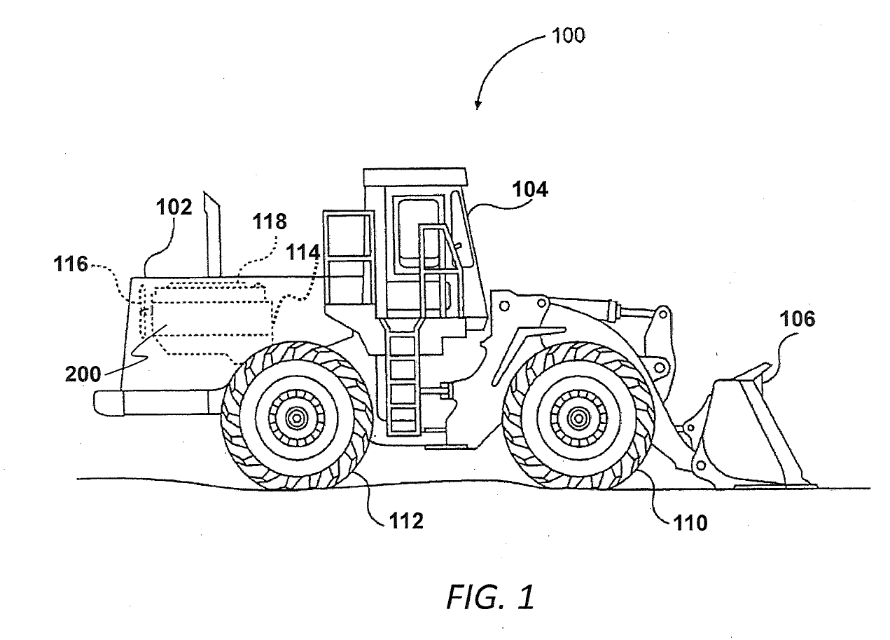

FIG. 1 shows an exemplary work machine 100 that may incorporate an intake system 200 as disclosed herein. The work machine 100 may include an engine housing 102, an operator cab 104, and a work implement 106 for digging and loading material. The exemplary work machine 100 shown is a wheel loader. The work implement 106 may be powered and controlled by a number of actuators including a tool actuator. The work machine 100 may include front and rear ground engaging devices, such as front wheels 110 and rear wheels 112 that support the work machine 100.

The engine housing 102 may include a power source such as an engine 114, and a cooling system 116. The engine 114 may provide power to the front and/or rear wheels 110, 112 through a transmission. The cooling system 116 may be configured to draw or push air through a heat exchanger such as a radiator and/or provide convective cooling to the engine 114. The engine 114 may be connected to the intake system 200. The engine 114 and the intake system 200 may be communicatively connected to and controlled by an Electronic Control Module 118 (ECM) or the like. The work machine 100 shown in FIG. 1 is merely exemplary. The work machine 100 may be a tractor, mining truck, on-highway truck, car, vehicle, off-highway truck, earth moving equipment, material handler, logging machine, compactor, construction equipment, power generator, pump, locomotive, marine application, mining machine, or any other device or application that may utilize the intake system 200 as disclosed herein.

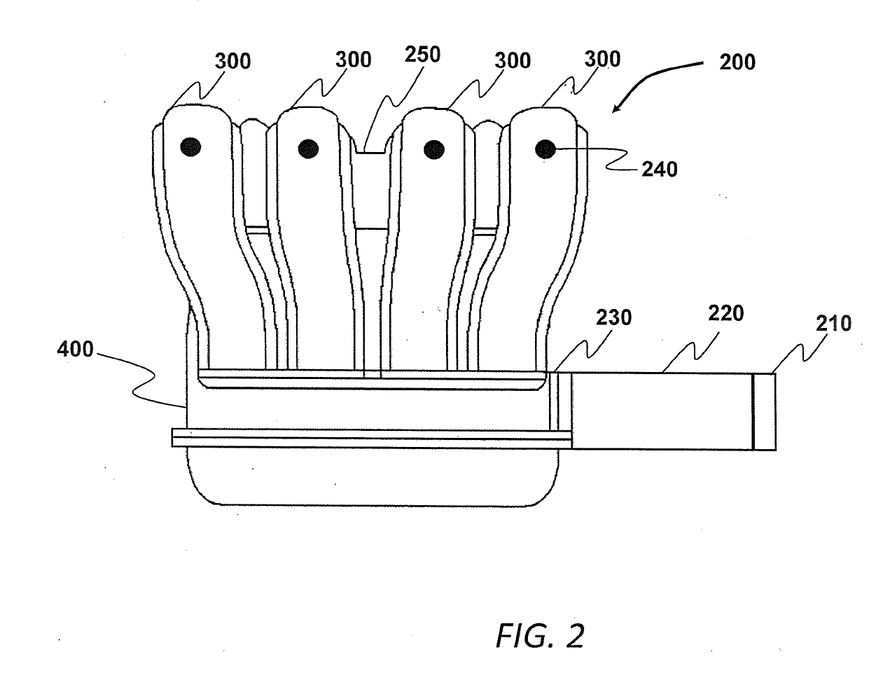

FIG. 2 shows an exemplary intake system 200. The intake system 200 may include components such as a plurality of intake runners 300 and a plenum 400. The intake system 200 may further include one or more components such as an air filter 210, an inlet pipe 230, a fuel injector 240, and the like. The intake system 200 may be implemented as a multiple fuel source system. In one aspect, the intake system 200 may be a dual fuel source system. The multiple fuel source system or dual fuel source system may provide a plurality of fuels to the intake system 200. For example, if implemented as a dual fuel source system, the intake system 200 may inject a gaseous fuel and a liquid fuel. For example, the gaseous fuel may be natural gas, propane, landfill gas or the like. A corresponding gaseous fuel system may include a pressurized source of gaseous fuel, a pressure regulator, valves, and the like. The liquid fuel may be diesel, gasoline, or the like. The corresponding liquid fuel system may include a source of liquid fuel, a fuel pump, a common rail, one or more fuel injectors, and the like. The intake system 200 may be implemented as a single source system as well. The intake system 200 may further include other components such as an air temperature sensor, a manifold pressure sensor, a mounting flange, and the like (not shown). Additionally, the intake system 200 may include a turbocharger 220 or similar component such as a compressor, supercharger, or the like that increases fuel-air pressure. In some aspects, the turbocharger 220 may not be utilized. The components in the intake system 200 are arranged in a way that air enters the intake system 200 and subsequently enters the engine 114.

In one aspect, the intake system 200 may include the air filter 210. Air flows through the air filter 210 to provide filtered air to the engine 114. In this regard, the air filter 210 substantially removes particulate matter from the air to reduce the potential for wear and or damage to the intake system 200 and the engine 114.

Thereafter the air flows into the plenum 400 that provides air for the engine 114 to feed from and also a mass damper to help reduce any oscillations or unsteady air flow. The size and shape of the plenum 400 can effect the overall engine performance. The air passes from the plenum 400 to the engine 114 via the intake runners 300. The intake runners 300 may be connected to an intake of the engine 114 such as a cylinder head 250 of the engine 114. The design of the intake runner 300 can affect the power and torque characteristics of an internal combustion engine 114. Within the intake runners 300, oscillating pressure waves can increase the volumetric efficiency of the engine 114. By careful design of the intake runner 300, an engine 114 may be ‘tuned’ to specific desired operating parameters, such as a specific operating RPM (revolutions per minute).

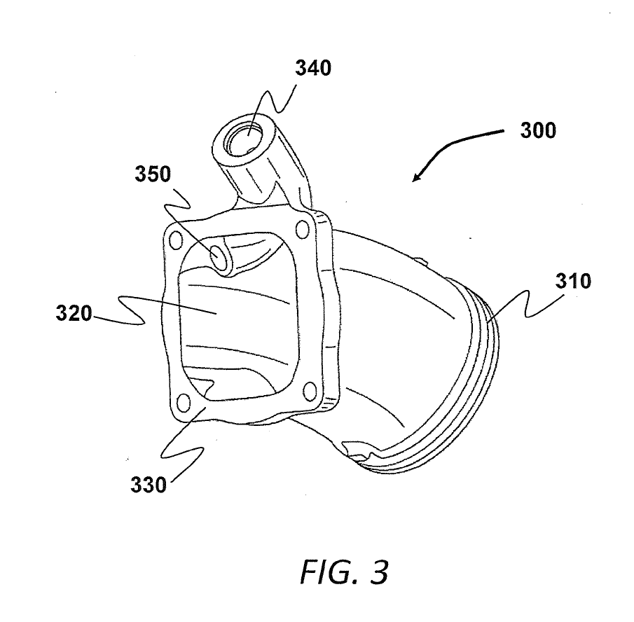

FIG. 3 shows an illustration of an exemplary intake runner 300 according to the disclosure. The intake runner 300 may include a connector 320. The air from the plenum 400 enters the intake runner 300 via an inlet connector 310 and the air travels through the connector 320. In one aspect, the connector 320 may be formed by a cylindrical surface of the intake runner 300. In some aspects, the connector 320 may be elliptical, rectangular or the like to provide air-to the engine 114. The connector 320 may form a pre-established volume. The air from the plenum 400 enters the connector 320 via the inlet connector 310. The inlet connector 310 may connect the plenum 400 with the connector 320. The inlet connector 310 may be cylindrical, elliptical, rectangular or the like to establish a connection with the plenum 400 and the intake runner 300. The intake runner 300 may include an outlet connector 330. The outlet connector 330 may connect the intake runner 300 with the engine 114. For example, the outlet connector 330 may connect the intake runner 300 to a cylinder head 250 of the engine 114. The outlet connector 330 may include a flange as disclosed in FIG. 3 for secure attachment to the engine 114. The outlet connector 330 may be cylindrical, elliptical, rectangular or the like to establish a connection between the intake runner 300 and the engine 114. The intake runner 300 may further include a fuel admission valve input 340 and a fuel admission point 350. In particular, the fuel admission valve input 340 may be a gaseous fuel admission valve input configured to be connected to a gaseous fuel system. More specifically, the fuel admission valve input 340 may receive fuel from a fuel admission valve or may be connected to a fuel admission valve to provide gaseous fuel to the intake runner 300.

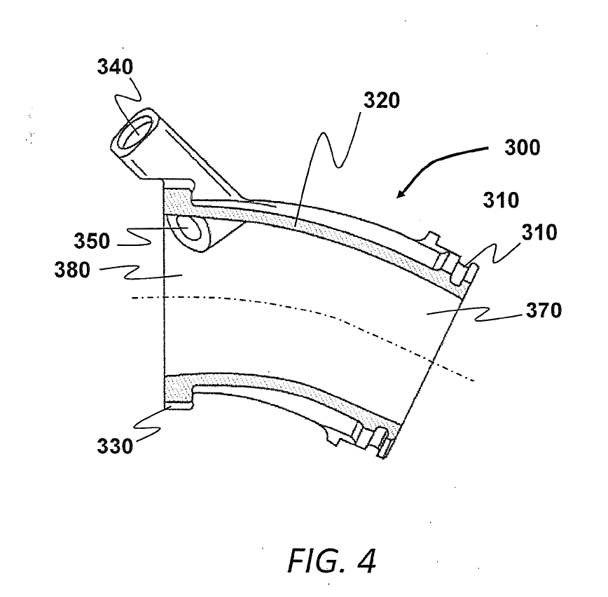

FIG. 4 shows a cross-sectional view of the exemplary intake runner 300 of FIG. 3. The fuel admission valve input 340 may be connected to the fuel admission point 350 so that fuel entering the fuel admission valve input 340 is subsequently introduced inside the connector 320 via the fuel admission point 350. The fuel admission valve input 340 may be connected on the connector 320. Following a longitudinal direction of the fuel admission point 350, one end of the fuel admission point 350 may be fluidly connected to the fuel admission valve input 340 and the other end of the fuel admission point 350 may be positioned inside the connector 320. In one aspect, one end of the fuel admission point 350 may protrude inside the connector 320. Optionally, the fuel admission valve input 340 may be configured to connect the fuel injector 240 (shown in FIG. 2) to the fuel admission point 350, and the fuel admission point 350 may hold the fuel injector 240 in the connector 320.

In one aspect, the longitudinal direction of the fuel admission point 350 may have an angle with respect to the center line (shown by the dot dashed line) of the cross-section of the connector 320 so that the fuel admission point 350 at least partially impedes the air stream flowing inside the connector 320. In some aspects, the longitudinal direction of the fuel admission point 350 may not be parallel to the center line of the cross-section of the connector 320. In another aspect, the longitudinal direction of the fuel admission point 350 may be configured to adjustably change the angle with respect to the center line of the cross-section of the connector 320. The fuel admission point 350 providing a flow of fuel at an angle with respect to the flow of air through the connector 320 may increase mixing of air with the injected fuel. The connector 320 may be divided into an inlet portion 370, a mixing portion 380, and an outlet portion. The fuel admission valve input 340 and the fuel admission point 350 may be positioned in the mixing portion 380. The inlet portion 370 of the connector 320 is located upstream of the fuel admission point 350.

It should be recognized that applications having multiple fuel admission points 350 may be used without departing from the scope of the disclosure. The type of connection between the fuel admission point 350 and the fuel admission valve input 340 may be achieved by using a clam, bellow, weld, or the like without departing from the scope of the disclosure. In a particular aspect, the intake runner 300 is arranged downstream of the turbocharger 220 such as a compressor and/or supercharger. Accordingly, the air pressure within the intake runner 300 is a higher pressure due to the configuration being downstream of the compressor for example.

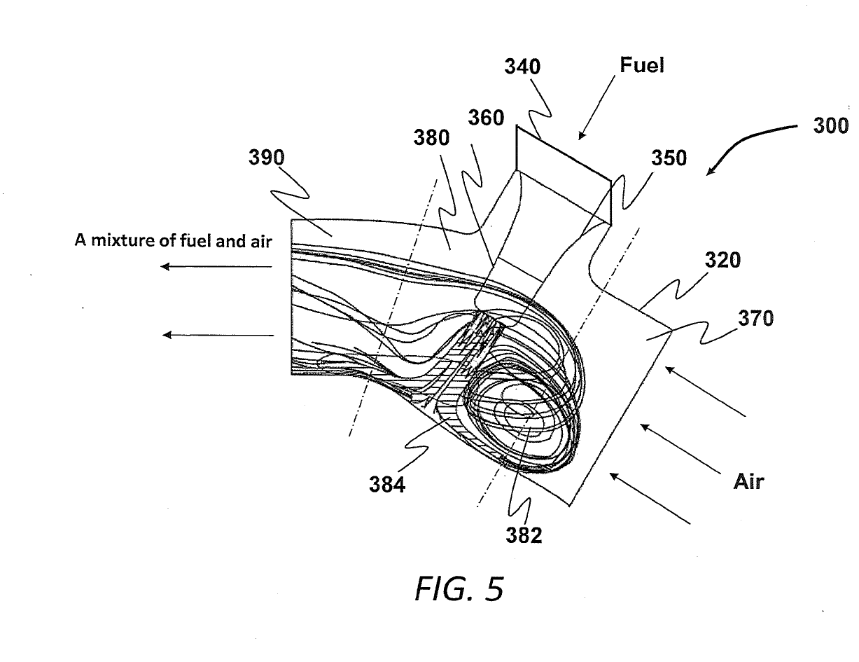

FIG. 5 is an illustration of a cross-sectional view of another aspect of the intake runner 300. In this aspect, the fuel admission point 350 may further extend into the connector 320. For example, the fuel admission point 350 may form a cylindrical shape within the connector 320. Other shapes of the fuel admission point 350 are contemplated as well. The connector 320 may be divided into an inlet portion 370, a mixing portion 380, and an outlet portion 390. The fuel admission valve input 340 and the fuel admission point 350 may be positioned in the mixing portion 380. The inlet portion 370 of the connector 320 is located upstream of the fuel admission point 350. In a flow direction of the connector 320, the inlet portion 370 may receive an air flow from the plenum 400. As the air passes through the inlet portion 370, the air may become impeded by the fuel admission point 350. In one aspect, the cylindrical portion of the fuel admission point 350 may divert the flow of the air. In another aspect, the cylindrical portion of the fuel admission point 350 may generate turbulence in the flow of the air.

The intake runner 300 may further include a delivery tube 360. The delivery tube 360 may be connected to the fuel admission point 350. In one aspect, the delivery tube 360 may be detachably connected to the fuel admission point 350. In some aspects, the delivery tube 360 may be connected to the fuel admission point 350 by using a clam, bellow, welding, brazing or the like without departing from the scope of the disclosure. The delivery tube 360 may be cylindrical in cross-section. The delivery tube 360 may alternatively be polygonal, elliptical or the like in cross-section. The fuel entering from the fuel admission point 350 passes through the delivery tube 360 and is introduced into the connector 320. The cross-sectional area of the fuel admission valve input 340 may be equal to or larger than the cross-sectional area of the delivery tube 360.

The length of the delivery tube 360 may vary. In one aspect, one end of the delivery tube 360 may be installed on the fuel admission point 350 and the other end of the delivery tube 360 may be positioned near or at the center line of the cross-section of the connector 320. In some aspects, one end of the delivery tube 360 may be positioned beyond the center line of the cross-section of the connector 320. A longitudinal direction of the delivery tube 360 may have an angle with respect to the center line of the cross-section of the connector 320 so that the delivery tube 360 at least partially impedes the air stream flowing from the inlet portion 370. In one aspect, the longitudinal direction of the delivery tube 360 may not be parallel to the center line of the cross-section of the connector 320. In some aspects, the longitudinal direction of the delivery tube 360 and/or the longitudinal direction of the fuel admission point 350 and the delivery tube 360 may have a 90 degree angle with respect to the center line of the cross-section of the connector 320. For example, the delivery tube 360 may have a 90 degree angle with respect to the center line of the cross-section of the connector 320 that results in a fuel injection 384.

The mixing portion 380 of the connector 320 may be adjacent to the inlet portion 370 and may be associated with a region where the location of the fuel admission point 350 is disposed within the connector 320. The mixing portion 380 may correspond to a region where the air flowing from the inlet portion 370 is combined with the fuel entering the connector 320 via the fuel admission point 350. The mixing of the air and the fuel substantially occurs in the mixing portion 380. In particular, mixing of the air and the fuel may occur in the mixing portion 380 as shown by the turbulent flow 382. In one aspect, the turbulent flow 382 may be formed in part because of the location of delivery tube 360. In one aspect, the turbulent flow 382 may be formed in part because of the injection of fuel by the delivery tube 360. The outlet portion 390 is located downstream of the fuel admission point 350. The outlet portion 390 corresponds to a region where a mixed stream of fuel and air passes through the intake runner 300. It should be recognized that any of the inlet portion 370, mixing portion 380 and outlet portion 390 may be of different shapes or sizes depending on the physical characteristics of the intake runner 300 without departing from the scope of the disclosure.

It is also contemplated that the intake runner 300 can be placed in an intake system 200 for a dual-fuel engine system 114. For example, gaseous or liquid fuel entering the fuel admission point 350 may be mixed with air and/or a mixture of air and another gaseous or liquid fuel in the mixing portion 380. In this regard, the other gaseous or liquid fuel may be injected upstream from the intake runner 300 or in the intake runner 300 itself. Alternatively, for a dual-fuel engine system 114, the other gaseous or liquid fuel may be injected downstream from the intake runner 300. For example, gaseous or liquid fuel may be directly injected into the engine system 114. In one aspect, the intake runner 300 may be configured to replace a conventional intake runner of a single fuel system in order to operate as a dual fuel system or a multiple fuel system. In this regard, the intake runner 300 may be configured with the size and shape consistent with a conventional intake runner of a single fuel system. By installing the intake runner 300 in the conventional intake system, the intake system may subsequently operate as a dual fuel or a multiple fuel source system.

### INDUSTRIAL APPLICABILITY

The disclosure may be applicable to any fuel-air intake system where mixing of the fuel and air is desired. Specifically, the disclosure may include an intake runner 300 with a fuel admission valve input 340 and a fuel admission point 350 where the fuel admission point 350 is configured to provide fuel injection that enables increased air-fuel mixing. The fuel may be fluid or gaseous fuel such as natural gas, propane, landfill gas, gasoline, diesel, and the like. In one aspect, the fuel may be a gaseous fuel such as natural gas, propane, landfill gas, and the like.

A function of the intake system 200 is to provide an air-fuel mixture to the engine 114. Providing a uniform air-fuel mixture to the engine 114 may be beneficial to increasing power, increasing combustion, increasing efficiency, and the like. The plenum 400 provides air to the intake runners 300. There can be one plenum 400 that all intake runners 300 connect, or a plurality of plenums 400 with one or more intake runners 300 connecting to each of the plenums 400.

In operation air is provided to the intake system 200. Fuel is introduced by the fuel admission valve input 340. The amount of fuel entering the intake runner 300 may be determined by the fuel admission valve input 340. In one aspect, the engine control module 118 may determine the amount of fuel entering the fuel admission valve input 340 by operation of an associated fuel admission valve.

It should be appreciated that the engine control module 118 may readily embody a general machine microprocessor capable of controlling numerous machine functions. Alternatively, the engine control module 118 may include a plurality of modules each of which performs one or more designated functions. In addition, various other circuits may be associated with engine control module 118, such as power supply circuitry, signal conditioning circuitry, data acquisition circuitry, signal output circuitry, signal amplification circuitry, and other types of circuitry.

The intake runner 300 arranged according to the disclosure may provide increased mixing of fuel and air within the intake runner 300. The air passing through the inlet portion 370 of the connector 320 enters the mixing portion 380 of the connector 320. The mixing portion 380 of the connector 320 provides mixing of the air and the fuel based in part upon the arrangement of the fuel admission valve input 340, the fuel admission point 350, and/or the delivery tube 360.

A method of mixing involves an arrangement of the fuel admission point 350 in the intake runner 300 as disclosed. The fuel admission point 350 within the connector 320 may partially divert the air stream about the fuel admission point 350. The diverted and undiverted air streams mix with the fuel introduced by the fuel admission point 350 and may thereby generate turbulent flows about the fuel admission point 350. The turbulent flows increase the mixture of the air in fuel as the turbulent flows pass through the mixing portion 380 and enter the outlet portion 390 of the connector 320.

To increase turbulent flows and generate more uniform mixing, the delivery tube 360 may be connected to the fuel admission point 350 where one end of the delivery tube 360 is connected to the fuel admission point 350 and the other end of the delivery tube 360 is positioned near the center line of the cross-section of the connector 320. The delivery tube 360 within the connector 320 at least partially diverts the air stream about the fuel admission point 350. The diverted and undiverted air streams mix with the fuel introduced by the delivery tube 360 and thereby generate turbulent flows about the delivery tube 360 in the mixing portion 380 as shown in FIG. 5. The turbulent flows generate at least in part a mixed stream as the turbulent flows pass through the mixing portion 380 and enter the outlet portion 390 of the connector 320.

The disclosure is universally applicable for use in an internal combustion engine for many types of off highway machines, such as, for example, machines associated with industries such as mining, construction, farming, transportation, etc. For example, the machine may be a tractor, mining truck, on-highway truck, car, vehicle, off-highway truck, earth moving equipment, material handler, logging machine, compactor, construction equipment, stationary power generator, pump, locomotive, marine application, mining machine, or any other device or application that may utilize the intake system 200 as disclosed herein. Similarly, the disclosure is universally applicable for use in an internal combustion engine for many types of generator sets that typically include a generator and a prime mover.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

We claim:

1. An intake system for a machine, comprising:
a connector including an inlet portion, a mixing portion, and an outlet portion wherein the connector is configured to guide air sequentially through the inlet portion, the mixing portion and the outlet portion within the connector;
a fuel admission valve input connected to an outer surface of the connector wherein the fuel admission valve input is configured to receive fuel that subsequently enters the connector; and
a fuel admission point placed within the connector, the fuel admission point configured to receive the fuel from the fuel admission valve input and introduce the fuel inside the connector,
wherein the fuel admission point is further configured to introduce the fuel inside the connector at an angle with respect to an airflow through the connector to generate a turbulent flow and cause mixing of air and fuel.

2. The intake system according to claim 1, wherein the fuel admission point is placed in the mixing portion of the connector.

3. The intake system according to claim 1, wherein the fuel admission point is configured to hold a fuel injector.

4. The intake system according to claim 1, wherein the fuel admission point further includes a delivery tube.

5. The intake system according to claim 1, wherein the inlet portion of the connector is located upstream of the fuel admission point wherein the inlet portion receives a flow of the air entering the connector.

6. The intake system according to claim 1, wherein the fuel admission point is configured to at least partially impede the air stream flowing from the inlet portion.

7. The intake system according to claim 1, wherein the outlet portion corresponds to a region where a mixed stream of the fuel and air flows from the mixing portion in the connector.

8. The intake system according to claim 1, further comprising:
a delivery tube connected to the fuel admission point at an angle with respect to an airflow through the connector to generate a turbulent flow and cause mixing of air and fuel.

9. The intake system according to claim 8, wherein a longitudinal direction of the delivery tube has a 90 degree angle with respect to the center line of the cross section of the connector.

10. The intake system according to claim 8, wherein a longitudinal direction of the delivery tube is not parallel to the center line of the cross-section of the connector.

11. The intake system according to claim 8, wherein one end of the delivery tube is connected to the fuel admission point and the other end of the delivery tube is positioned near the center line of the cross section of the connector.

12. The intake system according to claim 8, wherein one end of the delivery tube is connected to the fuel admission point and the other end of the delivery tube is positioned beyond the center line of the cross section of the connector.

13. A machine comprising the intake system of claim 1 and further comprising:
an engine; and
a turbocharger system.

14. A method for mixing fuel and air in an intake system for a machine, wherein the intake system comprises:
a connector including an inlet portion, a mixing portion and an outlet portion;
a fuel admission valve input wherein the fuel admission valve input is connected to an outer surface of the connector; and
a fuel admission point placed within the connector wherein the fuel admission point is configured to receive the fuel from the fuel admission valve input and introduce the fuel inside the connector,
the method comprising:
directing air sequentially through the inlet portion, the mixing portion and the outlet portion within the connector;
introducing the fuel from the fuel admission valve input to the fuel admission point;
introducing the fuel from the fuel admission point to the air flowing from the inlet portion in the connector at an angle with respect to an airflow through the connector to generate a turbulent flow and cause mixing of air and fuel; and
guiding the mixed stream of the air and the fuel to the outlet portion.

15. The method according to claim 14, further comprising:
generating a turbulent flow by introducing the fuel from the fuel admission point to the air flowing from the inlet portion.

16. The method according to claim 14, further comprising configuring the fuel admission point to be connected to a delivery tube.

17. The method according to claim 16, further comprising:
connecting the delivery tube to the fuel admission point;
flowing the fuel from the fuel admission point to the delivery tube; and
injecting the fuel from the delivery tube to the air stream flowing from the inlet portion.

18. An intake system for a machine, comprising:
means for directing air wherein the means for directing air includes an inlet portion, a mixing portion and an outlet portion wherein the means for directing air is configured to direct air sequentially through the inlet portion, the mixing portion and the outlet portion within the means for directing air;
means for receiving fuel wherein the means for receiving fuel is connected to an outer surface of the means for directing air wherein the means for receiving fuel is configured to receive the fuel that subsequently enters inside the means for directing air; and
means for introducing fuel placed within the means for directing air wherein the means for introducing fuel is configured to receive the fuel from the means for receiving fuel and introduces the fuel inside the means for directing air,
wherein the means for introducing fuel is configured to introduce the fuel inside the means for directing air at an angle with respect to an airflow through the means for directing air to generate a turbulent flow and cause mixing of air and fuel.

19. The intake system for a machine according to claim 18, further comprising:
a delivery means for introducing fuel connected to the means for introducing fuel.

20. The intake system for a machine according to claim 19, wherein a longitudinal direction of the delivery means for introducing fuel has a 90 degree angle with respect to the center line of the cross-section of the means for directing air.
